(19) United States
(12) Patent Application Publication
(10) Pub. No.: US 2021/0224252 A1
(43) Pub. Date: Jul. 22, 2021

(54) METHOD AND DEVICE FOR SEGMENTING LIST, STORAGE MEDIUM AND TERMINAL

(71) Applicant: PING AN TECHNOLOGY (SHENZHEN) CO., LTD., Shenzhen, Guangdong (CN)

(72) Inventor: Xiaohui WAN, Shenzhen (CN)

(73) Assignee: Ping An Technology (Shenzhen) Co., Ltd., Shenzhen, Guangdong (CN)

(21) Appl. No.: 16/093,631

(22) PCT Filed: Feb. 27, 2018
(86) PCT No.: PCT/CN2018/077357

§ 371 Date: Oct. 13, 2018

(30) Foreign Application Priority Data
Aug. 28, 2017 (CN) 201710747857.3

(51) Int. Cl. G06F 16/23; G06F 16/22

(52) U.S. Cl. CPC G06F 16/2379; G06F 16/2282

(57) ABSTRACT

A method for segmenting a list includes: acquiring user information and a list type of a to-be-segmented list through a list segmenting assembly; reading configuration information from a memory database, acquiring selectable dimensions from this configuration information according to the list type and the user information, and displaying the selectable dimensions; acquiring segmentation dimensions selected by a user and segmentation ranges corresponding to the segmentation dimensions through the list segmenting assembly, transmitting the list type, the segmentation dimensions selected by the user and corresponding segmentation ranges thereof to a big data platform to segment the to-be-segmented list according to the segmentation dimensions and the corresponding segmentation ranges thereof through the big data platform to obtain table results; and acquiring the table results through the list segmenting assembly, and generating follow-up tasks according to the table results and issuing to agents.

This application claims priority to Chinese Patent Application No. 201710747857.3 with a filing date of Aug. 28, 2017, entitled “Method and Device for Segmenting List, Storage Medium and Terminal”.

### TECHNICAL FIELD

The present disclosure relates to the technical field of communication, and more particularly to a method and a device for segmenting a list, a storage medium and a terminal.

### BACKGROUND OF THE PRESENT INVENTION

In insurance industry, list segmentation refers to segmenting one or more list information tables collected by salesman, and these lists are segmented into different subdivision categories according to specified attributes so as to pertinently issue lists with different subdivision categories to corresponding agents for following up and handling. Taking breakpoint lists and silent lists in different subdivision categories for example. The breakpoint list is a list whose business stream is broken, and the silent list is a list that has no messages any more after the business stream is initiated.

These lists should be issued to agents having operating authorization or corresponding skills to be followed up. However, in the prior art, a fixed segmentation model is configured for lists of different types, and list segmentation is performed according to segmentation dimensions specified by the corresponding segmentation models thereof through a backend database. When there are large amounts of list data, required processing time is long, when contents of a certain type of lists are added or deleted, a developer needs to modify codes so as to modify the segmentation dimensions. Accordingly, the existing list segmentation is long in response time, low in extendibility and inflexible in operation process.

### SUMMARY OF PRESENT INVENTION

Aiming at the problems of the list segmentation in the prior art that the response time is long and the extendibility is low, embodiments of the present disclosure provide a method and a device for segmenting a list, a storage medium and a terminal.

In a first aspect, embodiments of the present disclosure provide a method for segmenting a list, the method including: acquiring user information and a list type of a to-be-segmented list through a list segmenting assembly when list segmentation is performed; reading configuration information from a memory database, acquiring a selectable dimensions from the configuration information according to the list type and the user information, and loading a selection interface to display the selectable dimensions to remind a user corresponding to the user information to select the segmentation dimensions of the to-be-segmented list from the selectable dimensions; acquiring the segmentation dimensions selected by the user and the segmentation ranges corresponding to the segmentation dimensions through the list segmenting assembly; transmitting the list type, the segmentation dimensions selected by the user and the corresponding segmentation ranges thereof to a big data platform to acquire the to-be-segmented list according to the list type through the big data platform, and segmenting the to-be-segmented list according to the segmentation dimensions and the corresponding segmentation ranges thereof to obtain table results; and acquiring the table results returned by the list segmenting assembly, and generating follow-up tasks according to the table results and issuing to agents.

Further, before list segmentation is performed, the method further includes: updating configuration information of the segmentation dimensions at a preset time interval through the list segmenting assembly, and storing the updated configuration information to a preset memory database.

Further, after loading a selection interface to display the selectable dimensions, the method further includes: acquiring common dimensions corresponding to the list type; and setting the common dimensions corresponding to the list type on the selection interface to be in a selected state; wherein, the common dimensions are segmentation dimensions whose use times are larger than or equal to a first threshold within a first specified time range.

Further, after acquiring the segmentation dimensions selected by the user and the segmentation ranges corresponding to the segmentation dimensions through the list segmenting assembly, the method further includes: comparing the segmentation dimensions selected by the user with the common dimensions to screen non-common dimensions, wherein the non-common dimensions are segmentation dimensions whose use times are less than a first threshold within a first specified time range; and displaying the non-common dimensions to remind the user to confirm the selected segmentation dimensions.

Further, after acquiring the segmentation dimensions selected by the user and the segmentation ranges corresponding to the segmentation dimensions through the list segmenting assembly, the method further includes: updating track parameters of the list type according to the segmentation dimensions selected by the user, the track parameters including segmentation dimensions adopted by the list type and use times of each of the segmentation dimensions within a first specified time range; and updating the common dimensions of the list type based on the track parameters.

Ina second aspect, embodiments of the present disclosure also provide a device for segmenting a list, the device including: a first acquiring module for acquiring user information and a list type of a to-be-segmented list through a list segmenting assembly when list segmentation is performed; a reading and displaying module for reading configuration information from a memory database, acquiring selectable dimensions from the configuration information according to the list type and the user information, and loading a selection interface to display the selectable dimensions to remind the user corresponding to the user information to select segmentation dimensions of the to-be-segmented list from the selectable dimensions; a second acquiring module for acquiring segmentation dimensions selected by the user and segmentation ranges corresponding to the segmentation dimensions through the list segmenting assembly; a segmentation module for transmitting the list type, the segmentation dimensions selected by the user and the corresponding segmentation ranges thereof to a big data platform to acquire the to-be-segmented list according to the list type according to the big data platform, and segmenting the to-be-segmented list according to the segmentation dimensions and the corresponding segmentation ranges thereof to obtain table results; a generation module for acquiring the table results returned by the big data platform through the list segmenting assembly and generating follow-up tasks according to the table results and issuing to agents.

Further, the device further includes: a configuration module for, before list segmentation is performed, updating configuration information of segmentation dimensions at a preset time interval through a list segmenting assembly, and storing the updated configuration information in a preset memory database.

Further, the device further includes: a setting module for, after loading a selection interface to display the selectable dimensions, acquiring common dimensions corresponding to the list type; and setting the common dimensions corresponding to the list type on the selection interface to be in a selected state; wherein, the common dimensions are segmentation dimensions whose use times are larger than or equal to a first threshold within a first specified time range.

Further, the device further includes: a screening module for, after acquiring the segmentation dimensions selected by the user and the segmentation ranges corresponding to the segmentation dimensions through the list segmenting assembly, comparing the segmentation dimensions selected by the user with the common dimensions to screen non-common dimensions, wherein the non-common dimensions are segmentation dimensions whose use times are less than a first threshold within a first specified time range; and displaying the non-common dimensions to remind the user to confirm the selected segmentation dimensions.

Further, the device further includes: an updating module for, after acquiring the segmentation dimensions selected by the user and the segmentation ranges corresponding to the segmentation dimensions through the list segmenting assembly, updating track parameters of the list type according to the segmentation dimensions selected by the user, the track parameters including segmentation dimensions adopted by the list type and use times of each of the segmentation dimensions within a first specified time range; and updating the common dimensions of the list type based on the track parameters.

Ina third aspect, embodiments of the present disclosure also provide a computer readable storage medium on which a computer readable instruction is stored, wherein, when the computer readable instruction is executed by a processor, the following steps are realized: acquiring user information and a list type of a to-be-segmented list through a list segmenting assembly when list segmentation is performed; reading configuration information from a memory database, acquiring selectable dimensions from the configuration information according to the list type and the user information, and loading a selection interface to display the selectable dimensions to remind a user corresponding to the user information to select the segmentation dimensions of the to-be-segmented list; acquiring the segmentation dimensions selected by the user and segmentation ranges corresponding to the segmentation dimensions through the list segmenting assembly, transmitting the list type, the segmentation dimensions selected by the user and the corresponding segmentation dimension ranges thereof to a big data platform to acquire the to-be-segmented list according to the list type through the big data platform, and segmenting the to-be-segmented list according to the segmentation dimensions and the corresponding segmentation ranges thereof to obtain table results; and acquiring the table results returned by the big data platform through the list segmenting assembly, and generating follow-up tasks according to the table results and issuing to agents.

Ina fourth aspect, embodiments of the present disclosure also provide a terminal, including: a memory, a processor and a computer readable instruction stored on the memory and operated on the processor. When the processor executes the computer readable instruction, the following steps are realized: acquiring user information and a list type of a to-be-segmented list through a list segmenting assembly when list segmentation is performed; reading configuration information from a memory database, acquiring selectable dimensions from the configuration information according to the list type and the user information, and loading a selection interface to display the selectable dimensions to remind a user corresponding to the user information to select the segmentation dimensions of the to-be-segmented list from the selectable dimensions; acquiring the segmentation dimensions selected by the user and the segmentation ranges corresponding to the segmentation dimensions through the list segmenting assembly; transmitting the list type, the segmentation dimensions selected by the user and the corresponding segmentation ranges thereof to a big data platform to acquire the to-be-segmented list according to the list type through the big data platform, and segmenting the to-be-segmented list according to the segmentation dimensions and the corresponding segmentation ranges thereof to obtain table results; and acquiring the table results returned by the list segmenting assembly, and generating follow-up tasks according to the table results and issuing to agents.

Compared with the prior art, in embodiments of the present disclosure, through building of the list segmenting assembly, user information and the list type of the to-be-segmented list are acquired by the list segmenting assembly when list segmentation is performed; configuration information is read from the memory database, selectable dimensions are acquired from the configuration information according to the list type and the user information, and a selection interface is loaded to display the selectable dimensions to remind a user corresponding to the user information to select the segmentation dimensions of the to-be-segmented list from the selectable dimensions; then, the segmentation dimensions selected by the user and segmentation ranges corresponding to the segmentation dimensions are acquired through the list segmenting assembly; the list type, the segmentation dimensions selected by the user and the corresponding segmentation ranges thereof are transmitted to a big data platform to acquire the to-be-segmented list according to the list type through the big data platform and the to-be-segmented list is segmented according to the segmentation dimensions and the corresponding segmentation ranges thereof to obtain table results; finally, the table results returned by the big data platform are acquired through the list segmenting assembly, and follow-up tasks are generated through the list segmenting assembly and issued to agents. According to the present disclosure, interaction between users is completed by increasing the list segmenting assembly through the list segmenting assembly, thereby achieving flexible configuration of segmentation dimension. Moreover, a segmentation engine is optimized through combination of the memory database and the big data platform, thereby effectively improving segmentation efficiency and shortening segmentation time.

### DESCRIPTION OF THE DRAWINGS

In order to make the technical solutions in the disclosure or in the prior art described more clearly, the drawings associated to the description of the embodiments or the prior art will be illustrated concisely hereinafter. Obviously, the drawings described below are only some embodiments according to the disclosure. Numerous drawings therein will be apparent to one of ordinary skill in the art based on the drawings described in the disclosure without creative efforts.

FIG. 1 is a first flowchart of a method for segmenting a list according to embodiments of the present disclosure;

FIG. 2 is a second flowchart of a method for segmenting a list according to embodiments of the present disclosure;

FIG. 3 is a third flowchart of a method for segmenting a list according to embodiments of the present disclosure;

FIG. 4 is a fourth flowchart of a method for segmenting a list according to embodiments of the present disclosure;

FIG. 5 is a fifth flowchart of a method for segmenting a list according to embodiments of the present disclosure;

FIG. 6 is a structural diagram of a device for segmenting a list according to embodiments of the present disclosure; and

FIG. 7 is a schematic diagram of a terminal according to embodiments of the present disclosure.

### DETAILED DESCRIPTION OF PREFERRED EMBODIMENTS

In order to make the objects, technical solution and advantages of the present disclosure more clear, the present disclosure will be further described in detail with reference to the accompanying drawings and embodiments below. It should be understood that embodiments described here are only for explaining the present disclosure and the disclosure, however, should not be constructed as limited to the embodiment as set forth herein.

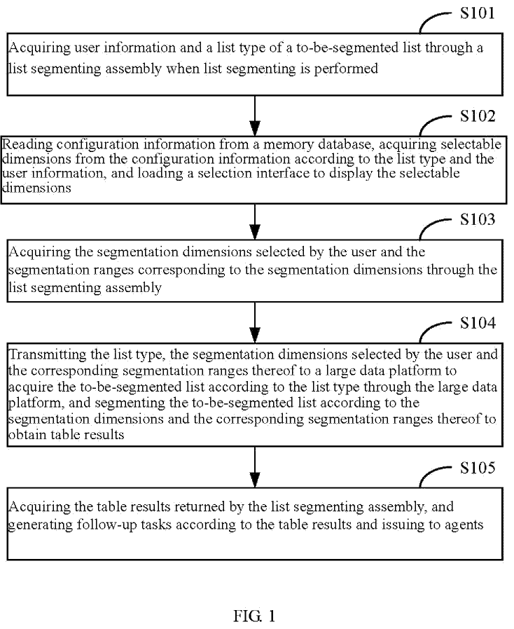

FIG. 1 shows a first procedure of a method for segmenting a list according to embodiments of the present disclosure.

On the basis that the existing list segmentation dimension is fixed and is low in extendibility, embodiments of the present disclosure build a list segmenting assembly, and interaction between users is completed through the list segmenting assembly, so that the user may select segmentation dimensions. In this embodiment, the list segmenting assembly adopts a pluggable design mode. When the list segmenting assembly is to be used, it is first added in form of an installation package and the display interface at the front end is configured, selectable dimensions are configured, and table results corresponding to lists are issued.

The method for segmenting a list according to embodiments of the present disclosure may be applied to a terminal. The terminal includes but is not limited to a computer, a server and a laptop. The list segmenting assembly is installed on the terminal, and may interact with a user.

Referring to FIG. 1, the method for segmenting a list includes:

In step S101, user information and a list type of a to-be-segmented list are acquired through a list segmenting assembly when list segmentation is performed.

In this embodiment, the list type is a business category of the to-be-segmented list. Exemplarily, the to-be-segmented list includes but is not limited to a vehicle insurance new channel marketing list, a vehicle insurance mobile terminal falling-off list, a vehicle insurance service list, an enterprise supplementary medical insurance marketing list and a commercial supplementary medical insurance marketing list. Correspondingly, the list type includes but is not limited to vehicle insurance new channel marketing, vehicle insurance mobile terminal falling-off, vehicle insurance service, enterprise supplementary medical insurance marketing and commercial supplementary medical insurance marketing. The user information is identity information of a user initiating list segmentation, and preferably is user account. In practical application, the user initiating operation of the list segmentation is generally a business administrator. Thus, when the list segmentation is performed, the business administrator needs to log in a web system using the user account, and then the list type of the to-be-segmented list is input on a front-end interface configured by the list segmenting assembly. The terminal may acquire the user information and the list type corresponding to the to-be-segmented list through the list segmenting assembly.

In step S102, configuration information is read from a memory database, selectable dimensions are acquired from the configuration information according to the list type and the user information, and a selection interface is loaded to display the selectable dimensions to remind a user corresponding to the user information to select the segmentation dimensions of the to-be-segmented list from the selectable dimensions.

In this step, the configuration information is configuration information of a list segmentation dimension and is used for designating all the segmentation dimensions contained in the list segmenting assembly. In embodiments of the present disclosure, the configuration information of the list segmentation dimension is stored in the memory database. As the name suggests, the memory database is a database in which data is placed in a memory to be directly operated. Compared with a disk, embodiments of the present disclosure store configuration information of the list segmentation dimensions in the memory database, which can greatly improve the efficiency of reading the list type and the selectable dimensions corresponding to the user information, thereby shortening response time of the interface. Optionally, the memory database may adopt TTServer which is a memory database of a Key-Value mode.

After the list type and the user information are acquired, the list segmenting assembly reads configuration information from the memory database, and acquires corresponding selectable dimensions according to the list type and the user information. In this embodiment, the selectable dimension should be understood as dimension information which may be selected by the user performing the current segmentation operation under the limitation of the list type. In embodiments of the present disclosure, different list types correspond to different dimension information, for example, dimension information corresponding to vehicle insurance new channel marketing includes customer dimension, channel party dimension and a vehicle dimension, and dimension information corresponding to vehicle insurance service includes customer dimension and recommend product dimension. Each business administrator takes charge of different businesses, dimension information checked by each business administrator is correlated to business charged by each business administrator, for example, the business administrator taking charge of vehicle insurance new channel marketing may check customer dimension and vehicle dimension, but cannot check recommend product dimension. Further, not all the users can check and select segmentation dimensions, which needs to undergo authorization monitoring. In view of this, embodiments of the present disclosure adopt the user account to determine whether the current user has an authorization for segmentation operation and businesses charged by the user.

After the selectable dimensions are acquired, the terminal loads a selection interface through the list segmenting assembly to allow the user to select segmentation dimensions required to be used in this segmentation operation from the selectable dimensions.

In step S103, the segmentation dimensions selected by the user and the segmentation ranges corresponding to the segmentation dimensions are acquired through the list segmenting assembly.

In embodiments of the present disclosure, each segmentation dimension includes a plurality of segmentation levels each having a corresponding value range, and the segmentation range is obtained after a value of each segmentation level is determined. Exemplarily, it is assumed that the selectable dimensions include customer dimension and vehicle dimension. The levels included by the customer dimension include gender, age and an insurance mechanism; levels included by the vehicle dimension include a purchasing date, a vehicle model, a license plate, insurance times, claim settlement amount and renewal times of insurance. When segmentation dimensions are selected, a user may select the customer dimension and/or the vehicle dimension. For the vehicle dimension, the business administrator may select one or more levels in the vehicle dimension according to the practical to-be-segmented list, for example, purchasing date, vehicle model, license plate and the like are selected, a value corresponding to each level is set, purchasing data is selected as 2016\01\01-2016\12\31, the vehicle model is a family car, and the license plate starts from Yue A, so purchasing date 2016\01\01-2016\12\31, family car vehicle model and license plate starting from Yue A jointly constitute the segmentation range of this vehicle dimension.

It can be seen from the above step S101 to the step S103 that the list segmenting assembly according to embodiments of the present disclosure allows the user to autonomously configure segmentation dimensions, thereby achieving the effects of flexibly configuring segmentation dimensions.

In step S104, the list type, the segmentation dimensions selected by the user and the corresponding segmentation ranges thereof are transmitted to a big data platform to acquire the to-be-segmented list according to the list type through the big data platform, and the to-be-segmented list is segmented according to the segmentation dimensions and the corresponding segmentation ranges thereof to obtain table results.

In this embodiment, communication is established between the terminal and the big data platform through a wired or wireless manner. Embodiments of the present disclosure store all list information sources for segmentation on the big data platform. These list information sources may be loaded into the big data platform through a data source backflow manner. After the list type is transmitted by the terminal, the segmentation dimensions selected by the user and the corresponding segmentation ranges thereof are acquired, the big data platform acquires the to-be-segmented list from the list information sources according to the list type, screens out corresponding list information from the to-be-segmented list according to the segmentation dimensions and the corresponding segmentation range thereof, and then fills the list information in a preconfigured table to generate table results in which one table result is a list of subdivided categories, each list in the table results corresponds to the same category, dimension and segmentation range. Embodiments of the present disclosure adopt the big data platform to perform list segmentation, and can further shorten operation time of a segmentation process by virtue of a high-speed processing ability of the big data platform to data.

In step S105, the table results returned by the list segmenting assembly are acquired, and follow-up tasks are generated according to the table results and issued to agents.

In this embodiment, by segmentation, each list in the table results corresponds to the same category, dimension and segmentation range, that is, each list in the table results has the same attribute. For example, each list is a normal list, a breakpoint list or a silence list or the like. The terminal generates the follow-up tasks of the agents according to the table results. One list information in the table results corresponds to one follow-up task, and the follow-up tasks are issued to agents having operation authorization or corresponding skills to be followed up.

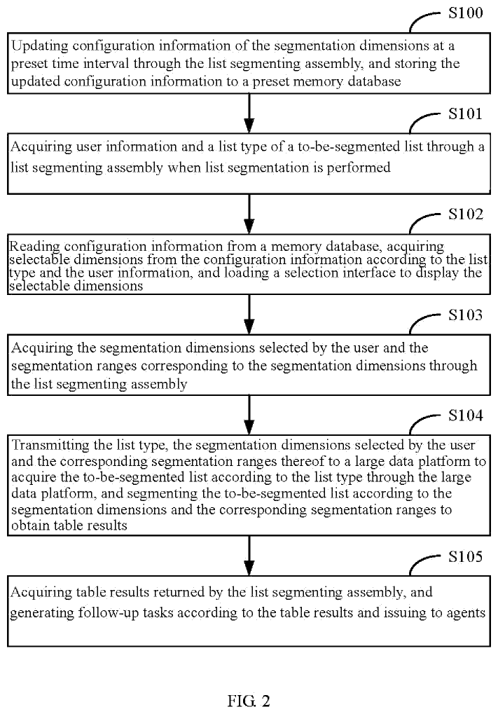

In the above embodiments, setting of configuration information of list segmentation dimensions is completed by a developer at a backstage, and the list segmenting assembly is cached to the memory database after being installed, so that the terminal may read corresponding selectable dimensions from the memory database in the subsequent segmentation process to be displayed to the user for selection. However, in practical application, form of insurance business, contact contents and other aspects are timely updated according to customer demand, laws and rules and the like, and configuration information of list segmentation dimensions stored in the memory database will not satisfy segmentation demand. In order to solve the above problem, a second procedure of a method for segmenting a list according to embodiments of the present disclosure is provided on the basis of the first procedure of the method for segmenting a list shown in FIG. 1, as shown in FIG. 2.

In FIG. 2, before the list type of the to-be-segmented list and the user information of segmentation operation are acquired through the list segmenting assembly, the method further includes:

In step S100, configuration information of the segmentation dimensions is updated at a preset time interval through the list segmenting assembly, and the updated configuration information is stored in a preset memory database.

In this embodiment, for the list segmenting assembly, the developer may update the configuration information at the backstage, including addition of new configuration contents or deletion of old configuration contents. The terminal triggers an updating instruction at a preset time interval so that the list segmenting assembly acquires the latest configuration information for updating according to the updating instruction, and stores the updated configuration information in a preset memory database, thereby completing automatic updating of the configuration information in the memory database. Optionally, the preset time interval is set according to actual demand, and is not described in detail here.

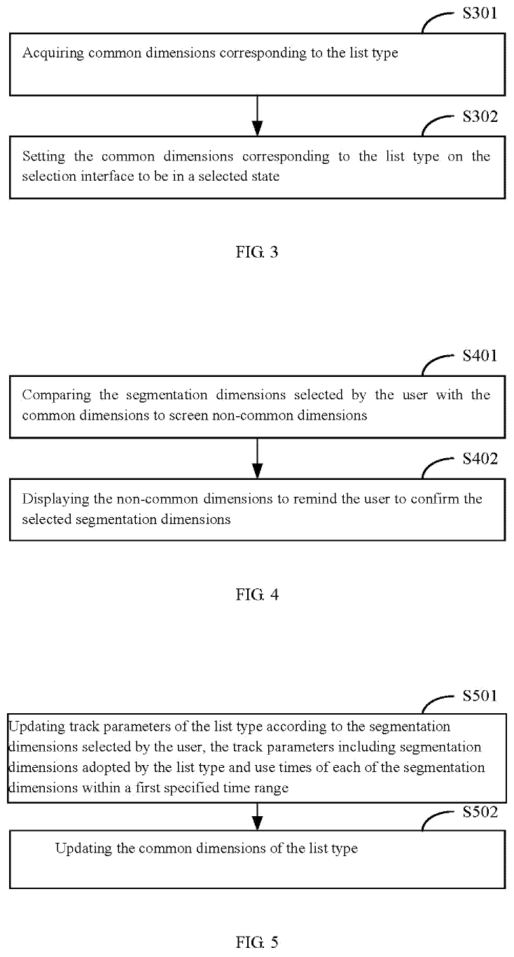

Optionally, as described above, in step S102, when a selection interface is loaded to allow the user to select the segmentation dimensions of the to-be-segmented list from the selectable dimensions, the user needs to set a corresponding value for each level since each list type includes a plurality of dimensions each further including a plurality of levels. When large-batch lists are issued to different skilled agents to be followed up, for the to-be-segmented list of the same list type, the business administrator selects the same segmentation dimension and the segmentation range corresponding to the segmentation dimension each time with a huge amount of tedious manual works and greatly increased manpower cost. In order to solve the above problems, a third procedure of a method for segmenting a list according to embodiments of the present disclosure is provided on the basis of the first procedure of the method for segmenting a list according to embodiments of the present disclosure, as shown in FIG. 3.

In FIG. 3, after a selection interface is loaded to display the selectable dimensions, the method further includes:

In step S301, corresponding common dimensions are acquired according to the list type.

In this embodiment, the list segmenting assembly maintains a common dimension table which records one or more common dimensions corresponding to all the list types. The common dimensions are segmentation dimensions whose use times are larger than or equal to a first threshold within a first specified time range. In this embodiment, the first specified time range is a historical time dating from the current moment, and the span of this historical time is set according to actual demand and is not described in detail here. Embodiments of the present disclosure acquire common dimensions corresponding to the list type in a manner of matching the list type based on the common dimension table.

In step S302, the common dimensions corresponding to the list type on the selection interface are selected to be in a selected state.

In embodiments of the present disclosure, different list types correspond to different common dimensions. By setting the common dimensions to be in a selected state, when there is only one common dimension, this common dimension is set to be in a selected state; when there are a plurality of common dimensions, the plurality of common dimensions are set to be in a selected state, optionally, or the former N common dimensions whose use times are sequenced in a descending sequence are set to be in a selected state, thereby effectively avoiding the user to repeatedly select the segmentation dimensions and the corresponding segmentation ranges thereof and also avoiding omission to effectively improve the selection efficiency of the segmentation dimensions.

Optionally, as described above, wrong selection often occurs due to many levels of segmentation dimensions. In order to solve the above problem, a fourth procedure of a method for segmenting a list according to embodiments of the present disclosure is provided on the basis of the first procedure of the method for segmenting a list according to FIG. 1, as shown in FIG. 4.

In FIG. 4, after the segmentation dimensions selected by the user and the segmentation ranges corresponding to the segmentation dimensions are acquired through the list segmenting assembly, the method further includes:

In step S401, the segmentation dimensions selected by the user are compared with the common dimensions to screen non-common dimensions.

As describe above, the common dimensions are segmentation dimensions whose use times are larger than or equal to a first threshold within a first specified time range. The common dimension is opposite to the non-common dimension, and therefore the non-common dimension is a segmentation dimension whose use times are less than the first threshold within the first specified time range. In the step S401, the comparing the segmentation dimensions selected by the user with the common dimensions may be as follows: traversing the segmentation dimensions selected by the user and judging whether the segmentation dimensions are the common dimensions. If NO, it is indicated that the segmentation dimensions are not the common dimensions and are labeled as the non-common dimensions; if YES, no processing is made.

In step S402, the non-common dimensions are displayed to remind the user to confirm the selected segmentation dimensions.

In this embodiment, the selection interface includes a confirmation marker, triggering the confirmation marker means that selection of the segmentation dimensions has been completed and a confirmation instruction is triggered, and the terminal will transmit the segmentation dimensions and the segmentation ranges thereof to the big data platform according to the confirmation instruction. Optionally, the displaying the non-common dimensions described in embodiments of the present disclosure may be as follows: when it is detected that the user triggers the confirmation marker, a prompt box is popped out, the prompt box includes a prompt text having non-common dimensions in this selection to remind the user to confirm the made selection. The prompt box further includes a “confirmation” marker and a “return” marker. If it is detected that the user triggers the “confirmation” marker, the segmentation dimensions and the segmentation ranges thereof are transmitted to the big data platform. If it is detected that the user triggers the “return” marker, the user returns back to the selection interface to regulate selection.

A wrong selection situation is often in that the user selects non-common dimensions. In embodiments of the present disclosure, the probability of wrong selection is effectively reduced by detecting non-common dimensions.

Optionally, as described above, the common dimensions are segmentation dimensions whose use times are larger than or equal to the first threshold within the first specified time range. The common dimension is capable of helping the user to select the segmentation dimension, thereby effectively improving the efficiency for selecting the segmentation dimension by the user. However, when the list information sources in the big data platform change, the common dimension cannot take an effect of helping the user to select the segmentation dimension. In order to solve the above problem, a fifth procedure of a method for segmenting a list according to embodiments of the present disclosure is provided on the basis of the first procedure of the method for segmenting a list provided in FIG. 1, as shown in FIG. 5.

In FIG. 5, after the segmentation dimensions selected by the user and the segmentation ranges corresponding to the segmentation dimensions are acquired through the list segmenting assembly, the method further includes:

In step S501, track parameters of the list type are updated according to the segmentation dimensions selected by the user, and the track parameters include segmentation dimensions adopted by the list type and use times of each segmentation dimension within the first specified time range.

In this embodiment, in order to ensure the timeliness of the common dimensions, for each list type, the terminal establishes and maintains a group of track parameters corresponding to the list type through the segmentation assembly. When a certain list type is segmented, after the segmentation dimensions selected by the user are acquired through the list segmenting assembly, the track parameters corresponding to the list type are updated, including: documenting the primarily selected segmentation dimension in the track parameters, and initializing the used times as 1; for the segmentation dimension that has been documented, if it is selected by the user in this segmentation operation, adding 1 to its use times within a first specified time range, and meanwhile screening out segmentation dimensions that are unused within a first specified time range to be deleted.

In step S502, the common dimensions of the list type are updated based on the track parameters.

After the updating of the track parameters is completed, each documented segmentation dimension in the track parameters and corresponding use times thereof are traversed, and whether the use times are larger than or equal to the first specified threshold is judged; if the use times are larger than or equal to the first specified threshold, it is indicated that the user frequently uses this segmentation dimension, and this segmentation dimension is marked as a common dimension; or else, it is indicated that the user infrequently uses this segmentation dimension, and this segmentation dimension is not a common dimension. When the list type is segmented next time, the updated common dimension is adopted to complete automatic selection operation.

It should be understood that in the above embodiments, the sequence numbers of various steps do not mean an execution sequence, and the execution sequence of various steps should be determined based on its functions and internal logic but not limit execution processes of embodiments of the present disclosure.

It is noted that those of ordinary skill in the art can understand that all or partial steps of the above embodiments can be completed through hardware, or by instructing relevant hardware with a computer readable instruction, the computer readable instruction can be stored in a computer readable storage medium that may be a read-only memory, a disk or an optical disk or the like.

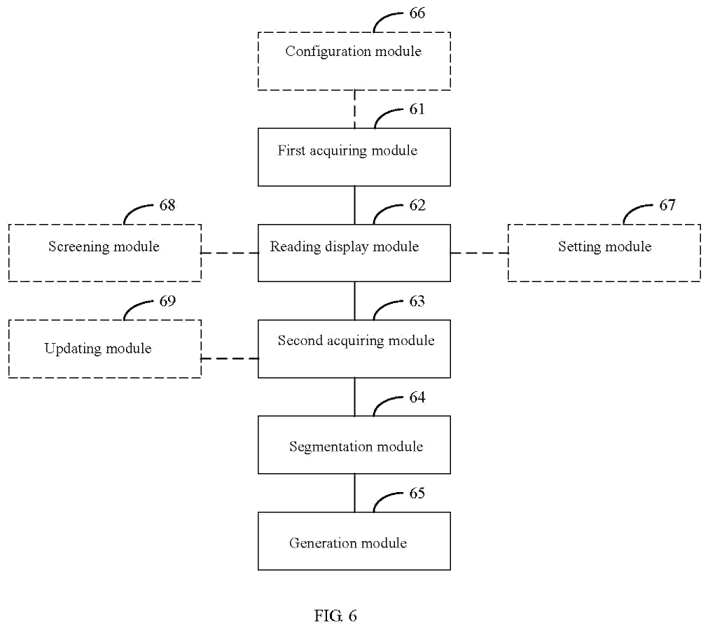

FIG. 6 shows a composition structure diagram of a device for segmenting a list according to embodiments of the present disclosure. For convenient illustration, parts correlated to embodiments of the present disclosure are only shown.

In embodiments of the present disclosure, the device for segmenting a list is used for achieving the method for segmenting a list described in embodiments of FIG. 1-FIG. 5, and it may be a soft unit, a hardware unit or a software and hardware combined unit built in a terminal. The terminal includes but is not limited to a computer, a server and a laptop.

Referring to FIG. 6, the device for segmenting a list includes: a first acquiring module 61 for acquiring user information and a list type of a to-be-segmented list through a list segmenting assembly when list segmentation is performed; a reading and displaying module 62 for reading configuration information from a memory database, acquiring selectable dimensions from the configuration information according to the list type and the user information, and loading a selection interface to display the selectable dimensions to remind the user corresponding to the user information to select segmentation dimensions of the to-be-segmented list from the selectable dimensions; a second acquiring module 63 for acquiring segmentation dimensions selected by the user and segmentation ranges corresponding to the segmentation dimensions through the list segmenting assembly; a segmentation module 64 for transmitting the list type, the segmentation dimensions selected by the user and the corresponding segmentation ranges thereof to a big data platform to acquire the to-be-segmented list according to the list type according to the big data platform, and segmenting the to-be-segmented list according to the segmentation dimensions and the corresponding segmentation ranges thereof to obtain table results; and a generation module 65 for acquiring the table results returned by the big data platform through the list segmenting assembly and generating follow-up tasks according to the table results and issuing to agents.

Optionally, the device further includes: a configuration module 66 for, before list segmentation is performed, updating configuration information of segmentation dimensions at a preset time interval through a list segmenting assembly, and storing the updated configuration information in a preset memory database.

Optionally, the device further includes: a setting module 67 for, after loading the selection interface to display the selectable dimensions, acquiring common dimensions corresponding to the list type; and setting the common dimensions corresponding to the list type on the selection interface to be in a selected state. The common dimensions are segmentation dimensions whose use times are larger than or equal to a first threshold within a first specified time range.

Optionally, the device further includes: a screening module 68 for, after acquiring the segmentation dimensions selected by the user and the segmentation ranges corresponding to the segmentation ranges through the list segmenting assembly, comparing the segmentation dimensions selected by the user with the common dimensions to screen non-common dimensions, wherein the non-common dimensions are segmentation dimensions whose use times are less than a first threshold within a first specified time range; and displaying the non-common dimensions to remind the user to confirm the selected segmentation dimensions.

The device further includes: an updating module 69 for, after acquiring the segmentation dimensions selected by the user and the segmentation ranges corresponding to the segmentation dimensions through the list segmenting assembly, updating track parameters of the list type according to the segmentation dimensions selected by the user, the track parameters including segmentation dimensions adopted by the list type and use times of each segmentation dimensions within the first specified time range; and updating the common dimensions of the list type based on the track parameters.

It is noted that the terminal in embodiments of the present disclosure may be used for achieving all the technical solutions in the above method embodiments. Those skilled in the art can clearly know that for convenience and conciseness of description, the abovementioned embodiments are exemplary for dividing functional units and modules only. In practical application, the above functions may completed by different functional units and modules according to demand, that is, the internal structure of the device is divided into different functional units or modules to complete all or partial functions described above. Various functional units and modules in embodiments may be integrated in one processing unit, or various units are physically present individually, or two or more than two units are integrated in one unit, the above integrated unit may be achieved in a hardware form or a software functional unit form. In addition, specific names of various functional units and modules are only for conveniently distinguishing each other but not limiting the protection scope of the present disclosure. The specific working processes of the above units and modules may refer to corresponding processes in the foregoing method embodiments and are not further described in detail here.

In the above embodiments, the description of each embodiment has its own emphasis, and parts that are not described in detail or recorded in a certain embodiment may refer to relevant description of other embodiments.

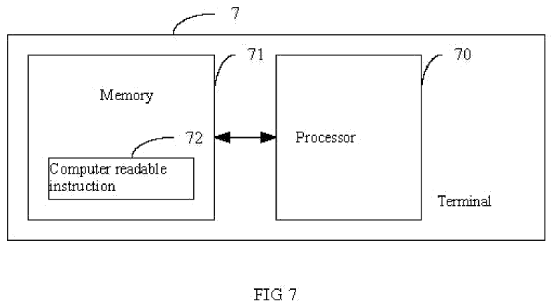

FIG. 7 is a diagram of a terminal according to embodiments of the present disclosure. As shown in FIG. 7, the terminal 7 of this embodiment includes: a processor 70, a memory 71 and a computer readable instruction 72 stored on the memory 71 and operated on the processor 70. When the processor 70 executes the computer readable instruction 72, steps in method embodiments for segmenting a list are realized, for example, step S101-S105 as shown in FIG. 1, step S100 as shown in FIG. 2, step S301-S302 as shown in FIG. 3, step S401-S402 as shown in FIG. 4 and step S501-S502 as shown in FIG. 5. Alternatively, when the processor 70 executes the computer readable instruction 72, functions of various modules/units in the above device embodiments for segmenting a list are realized, for example, functions of modules 61-69 as shown in FIG. 6.

Exemplarily, the computer readable instruction 72 may be divided into one or more modules/units which are stored in the memory 71 and executed by the processor 71 to complete this disclosure. The one or more modules/units may be an instruction segment capable of completing a series of computer readable instructions having specific functions, and this instruction segment is used for describing the execution process of the computer readable instruction 72 in the terminal 7. For example, the computer readable instruction 72 may be divided into a first acquiring module, a reading and displaying module, a second acquiring module, a segmentation module and a generation module, which have the following specific functions:

The first acquiring module is used for acquiring user information and a list type of a to-be-segmented list through a list segmenting assembly when list segmentation is performed.

The reading and displaying module is used for reading configuration information from a memory database, acquiring selectable dimensions from the configuration information according to the list type and the user information and loading a selection interface to display the selectable dimensions to remind the user corresponding to this user information to select segmentation dimensions of the to-be-segmented list.

The second acquiring module is used for acquiring the segmentation dimensions and segmentation ranges corresponding to the segmentation dimensions through the list segmenting assembly.

The segmentation module is used for transmitting the list type, the segmentation dimensions selected by the user and the corresponding segmentation ranges thereof to a big data platform to acquire the to-be-segmented list according to the list type according to the big data platform, and segmenting the to-be-segmented list according to the segmentation dimensions and the corresponding segmentation ranges thereof to obtain table results.

The generation module is used for acquiring the table results returned by the big data platform through the list segmenting assembly and generating follow-up tasks according to the table results and issuing to agents.

Further, the computer readable instruction 72 may also be divided into: a configuration module for, before list segmentation is performed, updating configuration information of segmentation dimensions at a preset time interval through a list segmenting assembly, and storing the updated configuration information in a preset memory database.

Further, the computer readable instruction 72 may also be divided into: a setting module for, after loading a selection interface to display the selectable dimensions, acquiring common dimensions corresponding to the list type; and setting the common dimensions corresponding to the list type on the selection interface to be in a selected state. The common dimensions are segmentation dimensions whose use times are larger than or equal to a first threshold within a first specified time range.

Further, the computer readable instruction 72 may also be divided into: a screening module for, after acquiring the segmentation dimensions selected by the user and the segmentation ranges corresponding to the segmentation dimensions through the list segmenting assembly, comparing the segmentation dimensions selected by the user with the common dimensions to screen non-common dimensions, wherein the non-common dimensions are segmentation dimensions whose use times are less than a first threshold within a first specified time range; and displaying the non-common dimensions to remind the user to confirm the selected segmentation dimensions.

Further, the computer readable instruction 72 may also be divided into: an updating module for, after acquiring the segmentation dimensions selected by the user and the segmentation ranges corresponding to the segmentation dimensions through the list segmenting assembly, updating track parameters of the list type according to the segmentation dimensions selected by the user, the track parameters including segmentation dimensions adopted by the list type and use times of each of the segmentation dimensions within a first specified time range; and updating the common dimensions of the list type based on the track parameters.

The terminal 7 may be a desktop computer, a laptop, a palmtop, a cloud server and other computing devices. The terminal may include but is not limited to the processor 70 and the memory 71. Those skilled in the art can understand that FIG. 7 is only an example of the terminal 7 but does not limit the terminal 7, the terminal 7 may include more or less parts than those shown in the drawing, or some components or different components are combined, for example, the terminal may also include an input/output device, a network access device and a bus.

The processor 70 may be a central processing unit (CPU), or other general processors, a digital signal process (DSP), an application specific integrated circuit (ASIC), a field-programmable array (FPGA) or other programmable logic devices, a discrete gate or a transistor logic device, a discrete hardware assembly or the like.

The general processing device may be a microprocessor or this processor may also be any conventional processor and the like, and the processor is a control center of the terminal and connects various parts of the whole terminal utilizing various interfaces and lines.

The memory 71 may be used for storing the computer readable instructions and/or modules, the processor achieves various functions of the terminal by operating or executing the computer readable instructions/modules stored in the memory and calling data stored in the memory. The memory may mainly include a program storage area and a data storage area, wherein, the program storage area may store an operation system, an application program required for at least one function (such as a voice playing function and a picture playing function) and the like; the data storage area may store data built according to use of the terminal and the like. In addition, the memory may include a high-speed random access memory and may also include a nonvolatile memory, for example a hard disk, an internal storage, a plug-in type hard disk, a smart media card (SMC), a secure digital (SD), a flash card, at least one disk memory device, a flash device or other volatile solid memory devices.

Those of ordinary skill in the art can appreciate that various exemplary units and algorithm steps described in combination with embodiments disclosed herein can be achieved in electronic hardware or a combination with a computer software and electronic hardware. Achievement of these functions in a hardware or software manner depends on specific application and design constraint condition of the technical solution. Professional persons may use different methods aiming at each specific application to achieve the described function, but, this achievement should not be considered to go beyond the scope of the present disclosure.

In embodiments according to the present disclosure, it should be understood that the disclosed device/terminal and method may be achieved through other manners. For example, the above embodiments for describing the device/terminal device are only illustrative, for example, a plurality of units or assemblies may be combined or may be integrated into another system, or some features may be ignored or are not executed. On the other hand, the displayed or discussed mutual coupling or direct coupling or communication connection may be achieved through indirect coupling or communication connection of some interfaces, devices or units, and may be of electrical, mechanical or other manners.

The units illustrated as separated components may be or may not be separated physically, components displayed as units may be or may not be physical units, namely, may be located in one place, or may be distributed to a plurality of network units. Partial or all the units are selected according to practical demand to achieve the purpose of the solution of this embodiment.

Moreover, various functional units in various embodiments of the present disclosure may be integrated in one processing unit, or various units may be physically and individually present, or two or more than two units may be integrated on one unit. The above integrated unit may be achieved both in a hardware form and in a software functional unit form.

If the integrated module/unit is achieved in the software functional unit form and sold or used as an independent product, it may be stored in the computer readable storage medium. Based on such understanding, all or partial procedures of the above embodiment method achieved by the present disclosure may also be completed by instructing relevant hardware with the computer readable instructions which may be stored in the computer readable storage medium, and when this computer readable instruction is executed by the processor, the steps of the above various method embodiments may be realized, wherein, the computer readable instruction includes a computer readable instruction code which may be of a source code form, an object code form, a executable file form or some intermediate forms and the like. The computer readable storage medium may include: any solids or devices capable of carrying the computer readable instruction codes, a record medium, a U disk, a mobile hard disk, a diskette, an optical disk, a computer memory, a read-only memory (ROM), a random access memory (RAM), an electrical carrier signal, a telecom signal and software distribution medium. It is noted that contents contained by the computer readable storage medium may be properly increased or decreased according to requirements of legislation and patent practice in a judicial jurisdiction region, for example, in some judicial jurisdiction regions, according to legislation and patent practice, the computer readable storage medium does not include the electrical carrier signal and the telecom signal.

The embodiments described above are only for illustrating the technical solution of the present disclosure but mot limiting thereto; although the present disclosure is described in detail with reference to the foregoing embodiments, those of ordinary skill in the art should understand that they still can modify the technical solutions described in the foregoing various embodiments, or make equivalent substitutions on partial technical features; however, these modifications or substitutions do not make the nature of the corresponding technical solution depart from the spirit and scope of technical solutions of various embodiments of the present disclosure, and all should be included within the protection scope of the present disclosure.

1. A method for segmenting a list, comprising:
acquiring user information and a list type of a to-be-segmented list through a list segmenting assembly when list segmentation is performed;
reading configuration information from a memory database, acquiring selectable dimensions from the configuration information according to the list type and the user information, and loading a selection interface to display the selectable dimensions to remind a user corresponding to the user information to select the segmentation dimensions of the to-be-segmented list from the selectable dimensions;
acquiring the segmentation dimensions selected by the user and the segmentation ranges corresponding to the segmentation dimensions through the list segmenting assembly,
transmitting the list type, the segmentation dimensions selected by the user and the corresponding segmentation ranges thereof to a big data platform to acquire a to-be-segmented list according to the list type through the big data platform, and segmenting the to-be-segmented list according to the segmentation dimensions and the corresponding segmentation ranges thereof to obtain table results; and
acquiring the table results returned by the big data platform through the list segmenting assembly, and generating follow-up tasks according to the table results and issuing to agents.

2. The method for segmenting a list according to claim 1, wherein, before list segmentation is performed, the method further comprises:
updating configuration information of segmentation dimensions at a preset time interval through a list segmenting assembly, and storing the updated configuration information to a preset memory database.

3. The method for segmenting a list according to claim 1, wherein, after the loading a selection interface to display the selectable dimensions, the method further comprises:
acquiring common dimensions corresponding to the list type; and
setting the common dimensions corresponding to the list type on the selection interface to be in a selected state;
wherein, the common dimensions are segmentation dimensions whose use times are larger than or equal to a first threshold within a first specified time range.

4. The method for segmenting a list according to claim 3, wherein, after acquiring the segmentation dimensions selected by the user and the segmentation ranges corresponding to the segmentation dimensions through the list segmenting assembly, the method further comprises:
comparing the segmentation dimensions selected by the user with the common dimensions to screen non-common dimensions, wherein the non-common dimensions are segmentation dimensions whose use times are less than the first threshold within the first specified time range; and
displaying the non-common dimensions to remind the user to confirm the selected segmentation dimensions.

5. The method for segmenting a list according to claim 4, wherein, after acquiring the segmentation dimensions selected by the user and the segmentation ranges corresponding to the segmentation dimensions through the list segmenting assembly, the method further comprises:
updating track parameters of the list type according to the segmentation dimensions selected by the user, wherein the track parameters comprise segmentation dimensions adopted by the list type and use times of each of the segmentation dimensions within the first specified time range; and
updating the common dimensions of the list type based on the track parameters.

6. A device for segmenting a list, comprising:
a first acquiring module for acquiring user information and a list type of a to-be-segmented list through a list segmenting assembly when a list segmentation is performed;
a reading and displaying module for reading configuration information from a memory database, acquiring selectable dimensions from the configuration information according to the list type and the user information, and loading a selection interface to display the selectable dimensions to remind a user corresponding to the user information to select segmentation dimensions of the to-be-segmented list from the selectable dimensions;
a second acquiring module for acquiring segmentation dimensions selected by the user and segmentation ranges corresponding to the segmentation dimensions through the list segmenting assembly;
a segmentation module for transmitting the list type, the segmentation dimensions selected by the user and the corresponding segmentation ranges thereof to a big data platform to acquire the to-be-segmented list according to the list type according to the big data platform, and segmenting the to-be-segmented list according to the segmentation dimensions and the corresponding segmentation ranges thereof to obtain table results; and
a generation module for acquiring the table results returned by the big data platform through the list segmenting assembly and generating follow-up tasks according to the table results and issuing to agents.

7. The device for segmenting a list according to claim 6, further comprising:
a configuration module for, before list segmentation is performed, updating configuration information of segmentation dimensions at a preset time interval through a list segmenting assembly, and storing the updated configuration information in a preset memory database.

8. The device for segmenting a list according to claim 6, further comprising:
a setting module for, after loading the selection interface to display the selectable dimensions, acquiring common dimensions corresponding to the list type; and setting the common dimensions corresponding to the list type on the selection interface to be in a selected state;
wherein, the common dimensions are segmentation dimensions whose use times are larger than or equal to a first threshold within a first specified time range.

9. The device for segmenting a list according to claim 8, further comprising:
a screening module for, after acquiring the segmentation dimensions selected by the user and the segmentation ranges corresponding to the segmentation ranges through the list segmenting assembly, comparing the segmentation dimensions selected by the user with the common dimensions to screen non-common dimensions, the non-common dimensions comprising segmentation dimensions whose use times are less than a first threshold within a first specified time range; and displaying the non-common dimensions to remind the user to confirm the selected segmentation dimensions.

10. The device for segmenting a list according to claim 9, further comprising:
an updating module for, after acquiring the segmentation dimensions selected by the user and the segmentation ranges corresponding to the segmentation dimensions through the list segmenting assembly, updating track parameters of the list type according to the segmentation dimensions selected by the user, wherein the track parameters comprise segmentation dimensions adopted by the list type and use times of each of the segmentation dimensions within the first specified time range; and updating the common dimensions of the list type based on the track parameters.

11. A computer readable storage medium on which a computer readable instruction is stored, wherein, when the computer readable instruction is executed by a processor, the following steps are realized:
acquiring user information and a list type of a to-be-segmented list through a list segmenting assembly when list segmentation is performed,
reading configuration information from a memory database, acquiring selectable dimensions from the configuration information according to the list type and the user information, and loading a selection interface to display the selectable dimensions to remind a user corresponding to the user information to select the segmentation dimensions of the to-be-segmented list;
acquiring the segmentation dimensions selected by the user and a segmentation ranges corresponding to the segmentation dimensions through the list segmenting assembly,
transmitting the list type, the segmentation dimensions selected by the user and the corresponding segmentation dimension ranges thereof to a big data platform to acquire the to-be-segmented list according to the list type through the big data platform, and segmenting the to-be-segmented list according to the segmentation dimensions and the corresponding segmentation ranges thereof to obtain table results; and
acquiring the table results returned by the big data platform through the list segmenting assembly, and generating follow-up tasks according to the table results and issuing to agents.

12. The computer readable storage medium according to claim 11, wherein, before list segmentation is performed, when a computer readable instruction is executed by a processor, the following steps are realized:
updating configuration information of segmentation dimensions at a present time interval through a list segmenting assembly, and storing the updated configuration information in a preset memory database.

13. The computer readable storage medium according to claim 11, wherein, after loading a selection interface to display the selectable dimensions, when the computer readable instruction is executed by a processor, the following steps are realized:
acquiring common dimensions corresponding to the list type; and
setting the common dimensions corresponding to the list type on the selection interface to be in a selected state;
wherein, the common dimensions are segmentation dimensions whose use times are larger than or equal to a first threshold within a first specified time range.

14. The computer readable storage medium according to claim 13, wherein, after acquiring the segmentation dimensions selected by the user and the segmentation ranges corresponding to the segmentation dimensions through the list segmenting assembly, when the computer readable instruction is executed by a processor, the following steps are realized:
comparing the segmentation dimensions selected by the user with common dimensions to screen non-common dimensions, wherein the non-common dimensions are segmentation dimensions whose use times are less than the first threshold within the first specified time range; and
displaying the non-common dimensions to remind the user to confirm the selected segmentation dimensions.

15. The computer readable storage medium according to claim 14, wherein, after acquiring the segmentation dimensions selected by the user and the segmentation ranges corresponding to the segmentation dimensions through the list segmenting assembly, when the computer readable instruction is executed by a processor, the following steps are realized:
updating track parameters of the list type according to the selected segmentation dimensions, wherein the track parameters comprise segmentation dimensions adopted by the list type and use times of each of the segmentation dimensions within a first specified time range; and
updating the common dimensions of the list type based on the track parameters.

16-20. (canceled)
